(19) United States
(12) Patent Application Publication
(10) Pub. No.: US 2025/0143343 A1
(43) Pub. Date: May 8, 2025

(54) MODULAR PRODUCTION LINE AND PROCESS FOR USING IT

(71) Applicant: SOCIETE DES PRODUITS NESTLE S.A., VEVEY (CH)

(72) Inventors: Peng-Siong Chong, York (GB); Mark Robert Knapp, York (GB); John Parkinson, York (GB); Stephen Chapman, York (GB)

(21) Appl. No.: 19/014,886

(22) Filed: Jan. 9, 2025

Related U.S. Application Data
(63) Continuation of application No. 16/758,255, filed on Apr. 22, 2020, now abandoned.

(30) Foreign Application Priority Data
Oct. 26, 2017 (EP) 17198650.8
Feb. 16, 2018 (EP) 18157182.9

(51) Int. Cl. A23G 3/34; A23G 1/00; A23G 7/00; A23G 7/02

(52) U.S. Cl. CPC A23G 3/0048; A23G 1/0063; A23G 1/0093; A23G 3/0025; A23G 7/0025; A23G 7/0093; A23G 7/02

(57) ABSTRACT

The present invention relates to the field of confectionery production, particularly to the use of a modular, flexible process and the use thereof in combination with the confectionery cooling step of the present invention.

### CROSS REFERENCE TO RELATED APPLICATIONS

The present application is a continuation of U.S. patent application Ser. No. 16/758,255, filed on Apr. 22, 2020, which is a National Stage of International Application No. PCT/EP2018/079430, filed on Oct. 26, 2018, which claims priority to European Patent Application No. 17198650.8, filed on Oct. 26, 2017, and European Patent Application No. 18157182.9, filed on Feb. 16, 2018, the entire contents of which are being incorporated herein by reference.

### FIELD OF THE INVENTION

The present invention relates to the field of confectionery production, particularly to the use of a modular, flexible process and the use thereof in combination with the confectionery cooling step of the present invention.

### BACKGROUND

Traditional Chocolate moulding lines are available in two main variants, namely Fixed Mould and Loose Mould designs. In both types of lines, plastic chocolate moulds are transported around a fixed circuit by a chain transport system. As the moulds travel around the circuit, a number of process steps are performed.

The disadvantage of this type of line is its relative inflexibility, the process steps have to be designed in from the start of the design process, or at least space has to be allowed on the line for future expansion and it is not always possible to predict what future products may need to be made. Therefore, it may in the future be necessary to make an engineering modification to the line, which can be expensive and time consuming.

Additionally, specifically, the cooling tunnel on a traditional moulding line forms the larger part of the asset due to the need to continuously transport the moulds, and the manner in which the moulds are transported, for at least 20-30 minutes whilst they cool at a temperature lower than ambient temperature. This necessitates a large, mechanically complex cooling tunnel, which is a negative from the point of view of efficient usage of space, and a large cost is associated with providing the cooling in terms of infrastructure.

EP0940086 and US2011/0045155 each discloses a partially robotic production line for confectionery. EP3111768 discloses a robotic, non-industrial scale confectionery production apparatus.

### SUMMARY

The present invention allows the same basic process steps that are used on a traditional confectionery moulding line and modularise them so that preferably each step is effected by a self-contained, movable module.

Additionally, in a preferred embodiment, the mould transportation in at least a portion of the production line of the present invention is replaced by robotic handling in order to eliminate the mechanical handling of the mould by chain systems, which are difficult to configure and maintain.

The present invention also provides a process where the cooling tunnel process is replaced by a stationary cooling of the moulds, preferably at a position removed from the remainder of the production line.

The present invention also provides a process with longer cooling times at higher temperatures.

Accordingly, the present invention allows for longer cooling times at higher temperatures without the need for a complex mould transport system through a cooling tunnel and the ancillary costs of installing, maintaining and cleaning.

Additionally, the present invention provides advantages in respect of hygiene. Owing to the modular system and independent, accessible moulds and modules, these moulds and modules may be cleaned more easily. The lower footprint, and removal of a chain driven rail dependent transportation system in the cooler specifically reduces cleaning effort. Also, the removal of mechanised, large, complex systems, affords removal of sources of metal filings and sources of grease, as well as lowering mechanical stress on the moulds.

The present invention also comprises a production line that comprises the various apparatus features defined in the process of the present invention.

Embodiments of the present invention are defined in the claims 1 to 15.

### FIGURES

The invention will now be illustrated by the following non-limiting FIGS. 1 to 15 that show examples of the present invention, in which:

FIG. 1 shows a robot module for use in an embodiment of the present invention

FIG. 2 shows a housing for a core process module for use in an embodiment of the present invention

FIG. 3 shows a depositor process module for use in an embodiment of the present invention

FIG. 4 shows a depositor process module for use in an embodiment of the present invention

FIG. 5 shows a side view of moulds for use in an embodiment of the present invention

FIG. 6 shows a view of the underside of the mould cavities for use in an embodiment of the present invention

FIG. 7 shows a stack of moulds on a substrate for use in an embodiment of the present invention

FIG. 8 shows the production processes in an embodiment of the present invention

FIG. 9 shows a production line of an embodiment of the present invention

FIG. 10 shows a production line of an embodiment of the present invention

FIG. 11 shows the cooling apparatus and mould stacks of an embodiment of the present invention

FIG. 12 shows the results of Example 1

FIG. 13 shows the position of deposition as carried out in Example 2

FIGS. 14 and 15 show DSC curves for chocolate samples cooled by differing methods

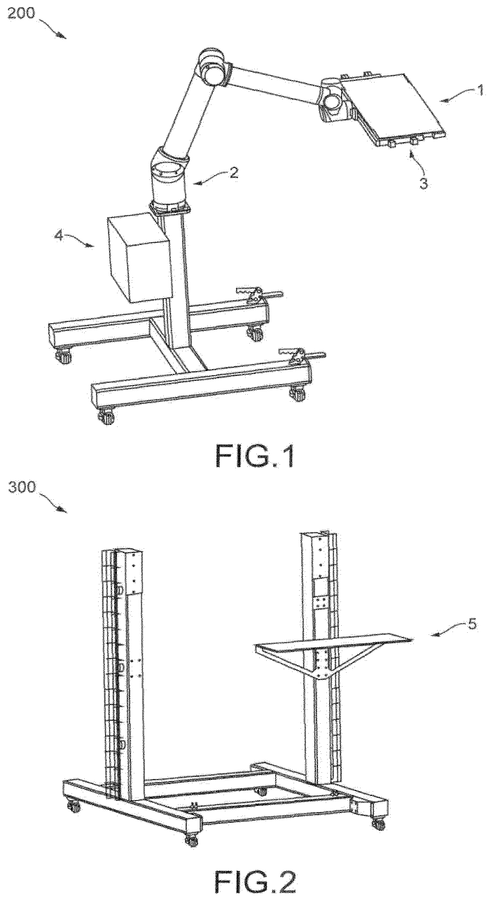

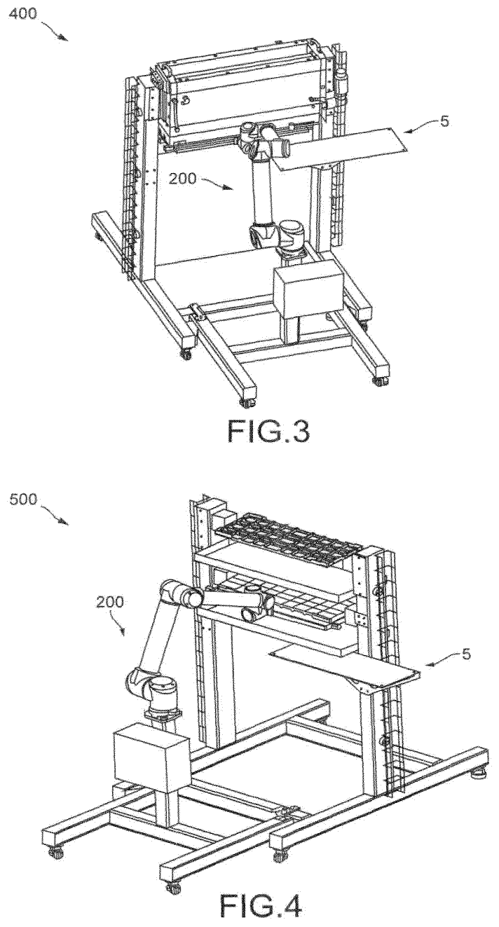

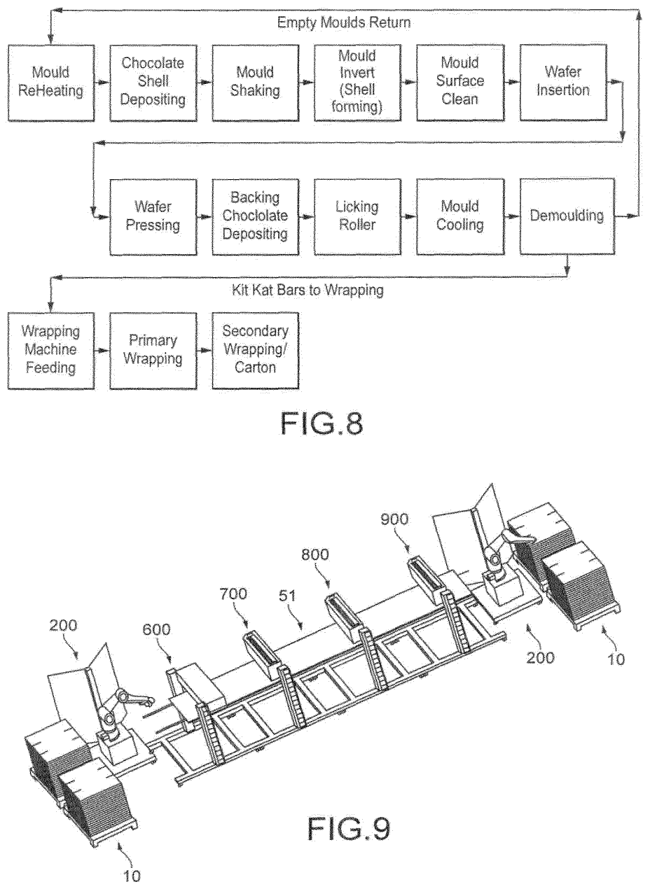

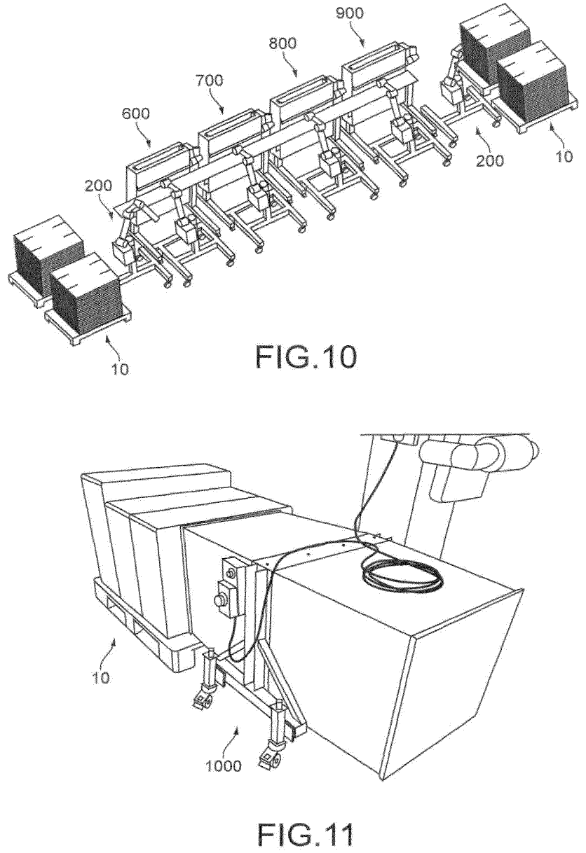

### LEGEND FOR FIGS. 1 to 13

| Ref no. | Element Name |
|---|---|
| 1 | Mould |
| 2 | Robot module arm |
| 3 | Robot module gripping portion |
| 4 | Robot module control box |
| 5 | Receiving feature |
| 6 | Aperture |
| 7 | Mould Protrusion |
| 8 | Interlocking recessed feature of mould for |
| | correspondence with robot module gripping portion |
| 9 | Substrate (e.g. a pallet) |
| 10 | Stack of moulds |
| 51 | Combined receiving feature |
| 200 | Robot module |
| 300 | Core process module |
| 400 | Depositor process module |
| 500 | Depositor process module |
| 600 | Mould conditioning process module |
| 700 | Inclusion depositing process module |
| 800 | Chocolate depositing process module |
| 900 | Licking process module |
| 1000 | Cooling apparatus (cooling module) |

### DETAILED DESCRIPTION

### Process Steps

As mentioned above, the present invention relates to a modular process. Within the scope of this invention the term modular means that at least one portion, preferably at least two portions, of the production line are capable of independent movement, i.e. the production line comprises at least two separate sections that can join together to form the production line. As mentioned above, preferably the at least one portion is self-contained and capable of independent movement.

In a preferred embodiment, the separate sections of the production line each comprise a process module that, optionally in conjunction with a robot module, undertakes a particular process step in the confectionery production process. In a preferred embodiment, the present invention comprises the use of at least two independent process modules that are each capable of carrying out at least one process step in the production process.

In the present invention, the term upstream module refers to a module that precedes a current module in the process flow and the term downstream module refers to the module that comes after the current module in the process flow.

In a preferred embodiment of the present invention, the process comprises the following steps:
1. Ingredient depositing—mould cavities are filled with confectionery ingredients
2. Cooling—the moulds are cooled to set the confectionery
3. Demoulding—The products are emptied from the moulds

In a preferred embodiment of the present invention, the process comprises the following steps:
1. Chocolate depositing—mould cavities are filled with chocolate
2. Cooling—the moulds are cooled to set the chocolate
3. Demoulding—The products are emptied from the moulds

In a preferred embodiment of the present invention, the process comprises the following steps:
1. Mould conditioning
2. Chocolate depositing—the mould cavities are filled with chocolate
3. Mould Shaking—the moulds are shaken to settle the chocolate in the mould
4. Licking roller—the surface of the mould is cleaned
5. Cooling—the moulds are cooled to set the chocolate
6. Mould twisting—the moulds are processed to release the product from the moulds
7. Demoulding—The products are emptied from the moulds

In a preferred embodiment, the cooling step of the process is as described below.

In a preferred embodiment of the present invention, the demoulded confectionery products are packaged subsequent to the demoulding and optionally subsequently undergo a secondary packaging.

In a preferred embodiment of the present invention, at least one robot module is used to position moulds for mould conditioning, cooling and after demoulding. In a preferred embodiment, at least one robot module is used to unstack moulds prior to mould conditioning, stack moulds prior to cooling and/or stack moulds after demoulding and mould cleaning for reusing.

In a preferred embodiment, the moulds are stacked directly on top of each other so that they are in direct contact. Alternatively, the moulds may be placed in containers that comprise features that hold a number of moulds, for example racks. However, by stacking the moulds directly on top of each other the number of process steps and number of pieces of different equipment may be reduced.

In an embodiment, the racks are in line, i.e. are an integrated part of the process line. Alternatively, the racks are out of the process line. In an embodiment, the racks may support the mould on two or three sides of the mould. For example, two sides of the rack are open so that the mould may be removed from a different side to which the mould is originally placed in or one side of the rack is open for placing and removing a mould. In an embodiment, the moulds may be placed in individual racks by a robot. Alternatively, or as well as, if the racks are in line, the movement of moulds downstream fills up the racks. For example, when one layer of racks is filled, a robot is used to fill any other layers. In an embodiment, the moulds are removed from the racks using a robot. In an alternative embodiment, the introduction of subsequent moulds into racks pushes out earlier moulds in the racks.

In an embodiment of the present, additional process steps may be introduced in order to enable the production of a more complex product. For example, these additional process steps may be selected from the list comprising: inclusion deposition, wafer insertion, wafer pressing, baking, filling deposition etc.

In a preferred embodiment of the present invention, the process comprises the step of depositing inclusions into the confectionery. The nature of the inclusions is not particularly limited, preferably the inclusions are selected from the group comprising of nuts, fruit, dried fruit, caramel, cereals, popcorn, pretzels, marshmallow, popcorn, biscuits (cookies), chocolate and combinations thereof, wherein the inclusions may be added whole or in pieces/fragments.

In an embodiment of the present invention, the depositing of each different inclusion is carried out by separate process modules. Alternatively, all inclusions may be deposited by a single depositor.

In a preferred embodiment of the present invention, the confectionery product is transferred between process modules of the production line in a mould, i.e. from the current module to an upstream module, of the production line by at least one robot module. In an embodiment of the present invention, a separate robot module is used to transfer the moulds between each two adjacent process modules.

In an embodiment of the present invention, the moulds may be transferred between process modules by an upstream robot module placing moulds so that a subsequently placed mould pushes the preceding mould further down the process line.

Accordingly, in an embodiment of the present invention, a process is provided that comprises the steps of a robot module unstacks moulds, transfers the moulds to a receiving feature of a mould conditioning module, subsequent unstacking and position of moulds pushes the preceding mould downstream in the process, after processing a robot module stacks the moulds for a cooling process.

In a preferred embodiment of the present invention, the receiving features of more than one process module form a means for transferring the moulds down the production line using the impetus provided by an upstream robot pushing the moulds down the line using a subsequently placed mould. A specific arrangement of this embodiment is displayed in FIG. 9.

In a preferred embodiment, the receiving features of at least the mould conditioning module and depositing module form a feature that enables transport of the moulds down the production line. In a preferred embodiment, the receiving features of at least the mould conditioning module, an inclusion depositing module, a chocolate depositing module and a licking module form a means for transferring the modules downstream.

By virtue of the modular production line used in the present invention, the incorporation of additional process modules is straightforward and enables a highly flexible production process to be achieved.

In a preferred embodiment, the processes of the present invention are operated on an industrial scale. In a preferred embodiment, the process of the present invention processes greater than 5 moulds per minute at a process module, preferably greater than 10 moulds per minute at a process module, and more preferably greater than 15 moulds per minute. In a preferred embodiment, the upper limit for processing is controlled by the equipment used and the confectionary being produced, so, in theory, there is potentially no single upper limit. However, for example, processes of the present invention process fewer than 100 moulds per minute, for example fewer than 75 moulds per minute, fewer than 60 moulds per minute, fewer than 30 moulds per minute, for example 25 or fewer moulds per minute.

### Product

In a preferred embodiment of the present invention, the confectionery product produced is one selected from the group comprising sugar confectionery, chocolate confectionery or baked confectionery. In a preferred embodiment of the present invention, the confectionery produced comprises chocolate.

In an embodiment, compositions produced by the invention may usefully be chocolate products (as defined herein), more usefully be chocolate or a chocolate compound. Independent of any other legal definitions that may be used compositions of the invention that comprises a cocoa solids content of from 25% to 35% by weight together with a milk ingredient (such as milk powder) may be informally referred to herein as ‘milk chocolate’ (which term also encompasses other analogous chocolate products, with similar amounts of cocoa-solids or replacements therefor). Independent of any other legal definitions that may be used compositions of the invention that comprises a cocoa solids content of more than 35% by weight (up to 100% (i.e. pure cocoa solids) may be informally referred to herein as ‘dark chocolate’ (which term also encompasses other analogous chocolate products, with similar amounts of cocoa-solids or replacements therefor).

In a preferred embodiment, prior to cooling the chocolate-product may be tempered to have a temper index of between 3 and 8, preferably between 4 and 8 and preferably between 4 and 6. A Greer or a Sollich temper meter may be used to measure this index.

The term ‘chocolate’ as used herein denotes any product (and/or component thereof if it would be a product) that meets a legal definition of chocolate in any jurisdiction and also include product (and/or component thereof) in which all or part of the cocoa butter (CB) is replaced by cocoa butter equivalents (CBE) and/or cocoa butter replacers (CBR).

The term ‘chocolate compound’ as used herein (unless the context clearly indicates otherwise) denote chocolate-like analogues characterized by presence of cocoa solids (which include cocoa liquor/mass, cocoa butter and cocoa powder) in any amount, notwithstanding that in some jurisdictions compound may be legally defined by the presence of a minimum amount of cocoa solids.

The term ‘chocolate product’ as used herein denote chocolate, compound and other related materials that comprise cocoa butter (CB), cocoa butter equivalents (CBE), cocoa butter replacers (CBR) and/or cocoa butter substitutes (CBS). Thus, chocolate product includes products that are based on chocolate and/or chocolate analogues, and thus for example may be based on dark, milk or white chocolate.

Unless the context clearly indicates, otherwise it will also be appreciated that in the present invention, any one chocolate product may be used to replace any other chocolate product and neither the term chocolate nor compound should be considered as limiting the scope of the invention to a specific type of chocolate product. Preferred chocolate product comprises chocolate and/or compound, more preferred chocolate product comprises chocolate, most preferred chocolate product comprises chocolate as legally defined in a major jurisdiction (such as Brazil, EU and/or US).

The term ‘choco-coating’ as used herein (also refers to a ‘choco-shell’) denotes coatings made from any chocolate product. The terms ‘chocolate coating’ and ‘compound coating’ may be defined similarly by analogy. Similarly the terms ‘choco-composition, (or mass)’, ‘chocolate composition (or mass)’ and ‘compound composition (or mass)’ denote compositions (or masses) that respectively comprise chocolate product, chocolate and compound as component(s) thereof in whole or part. Depending on their component parts the definitions of such compositions and/or masses may of course overlap.

The term ‘chocolate product confectionery as used herein denotes any foodstuff which comprises chocolate product and optionally also other ingredients and thus may refer to foodstuffs such confections, wafers, cakes and/or biscuits whether the chocolate product comprises a choco-coating and/or the bulk of the product. Chocolate product confectionery may comprise chocolate product in any suitable form for example as inclusions, layers, nuggets, pieces and/or drops. The confectionery product may further contain any other suitable inclusions such as crispy inclusions for example cereals (e.g. expanded and/or toasted rice) and/or dried fruit pieces.

The chocolate product produced by the invention may be used to mould a tablet and/or bar, to coat confectionery items and/or to prepare more complex confectionery products. Optionally, prior to its use in the preparation of a chocolate product confectionery product, inclusions according to the desired recipe may be added to the chocolate product. As it will be apparent to a person skilled in the art, in some instances the product of the invention will have the same recipe and ingredients as the corresponding composition and/or mass while in other instances, particularly where inclusions are added or for more complex products, the final recipe of the product may differ from that of the composition and/or mass used to prepare it.

In one strongly preferred embodiment of the invention, the chocolate product confectionery product comprises a substantially solid moulded choco-tablet, choco-bar and/or baked product surrounded by substantial amounts of chocolate product. These products are prepared for example by substantially filling a mould with chocolate product and optionally adding inclusions and/or baked product therein to displace chocolate product from the mould (so-called wet shelling processes), if necessary further topping up the mould with chocolate product. For such strongly preferred products of the invention the chocolate product forms a substantial or whole part of the product and/or a thick outside layer surrounding the interior baked product (such as a wafer and/or biscuit laminate). Such solid products where a mould is substantially filled with chocolate are to be contrasted with products that comprise moulded thin chocolate shells which present different challenges. To prepare a thin-coated chocolate shell a mould is coated with a thin layer of chocolate, the mould being inverted to remove excess chocolate and/or stamped with a cold plunger to define the shell shape and largely empty the mould. The mould is thus coated with a thin layer of chocolate to which further ingredients and fillings may be added to form the interior body of the product.

Unless the context herein clearly indicates, otherwise it will also be well understood by a skilled person that the term chocolate product confectionery as used herein can readily be replaced by and is equivalent to the term chocolate confectionery as used throughout this application and in practice these two terms when used informally herein are interchangeable. However, where there is a difference in the meaning of these terms in the context given herein, then chocolate confectionery and/or compound confectionery are preferred embodiments of the chocolate product confectionery of the present invention, a preferred embodiment being chocolate confectionery.

Preferred chocolate product confectionery may comprise one or more ingredients, for example selected from the group consisting of: chocolate product(s), compound product(s), chocolate coating(s) and/or compound coating(s). The products may comprise uncoated products such as choco-bar(s) and/or choco-tablet(s) with or without inclusions and/or products coated with chocolate product such as coated biscuits, cakes, wafers and/or other confectionery items. More preferably and/or alternatively any of the aforementioned may comprise one or more cocoa butter replacer(s) (CBR), cocoa-butter equivalent(s) (CBE), cocoa-butter substitute(s) (CBS) and/or any suitable mixture(s) thereof.

In chocolate product confectionery, the cocoa butter (CB) may be replaced by fats from other sources. Such products may generally comprise one or more fat(s) selected from the group consisting of: lauric fat(s) (e.g. cocoa butter substitute (CBS) obtained from the kernel of the fruit of palm trees); non-lauric vegetable fat(s) (e.g. those based on palm or other specialty fats); cocoa butter replacer(s) (CBR); cocoa butter equivalent(s) (CBE) and/or any suitable mixture(s) thereof. Some CBE, CBR and especially CBS may contain primarily saturated fats and very low levels of unsaturated omega three and omega six fatty acids (with health benefits). Thus in one embodiment in chocolate product confectionery of the invention such types of fat are less preferred than CB.

One embodiment of the invention provides a multi-layer product optionally comprising a plurality of layers of baked foodstuff (preferably selected from one or more wafer and/or biscuit layers, and/or one or more fillings layers there between with at least one coating layer located around these layers foodstuff, the coating comprising a chocolate product of or prepared according to the invention.

A further embodiment of the invention provides a chocolate product confectionery product, further coated with chocolate (or equivalents thereof, such as compound) for example a praline, chocolate shell product and/or chocolate coated wafer or biscuit any of which may or may not be layered. The chocolate coating can be applied or created by any suitable means, such as enrobing or moulding. The coating may comprise a chocolate product of or prepared according to the invention.

Another embodiment of the invention provides a chocolate product confectionery product of and/or used in the present invention, that comprises a filling surrounded by an outer layer for example a praline, chocolate shell product.

In another preferred embodiment of the invention the foodstuff comprises a multi-layer coated chocolate product comprising a plurality of layers of wafer, chocolate product, biscuit and/or baked foodstuff, with filling sandwiched between them, with at least one layer or coating being a chocolate product (e.g. chocolate) of the invention. Most preferably the multi-layer product comprises a chocolate product confectionery product (e.g. as described herein) selected from sandwich biscuit(s), cookie(s), wafer(s), muffin(s), extruded snack(s) and/or praline(s). An example of such a product is a multilayer laminate of baked wafer and/or biscuit layers sandwiched with filling(s) and coated with chocolate.

Baked foodstuffs used in the invention may be sweet or savoury. Preferred baked foodstuffs may comprise baked grain foodstuffs which term includes foodstuffs that comprise cereals and/or pulses. Baked cereal foodstuffs are more preferred, most preferably baked wheat foodstuffs such as wafer(s) and/or biscuit(s). Wafers may be flat or shaped (for example into a cone or basket for ice-cream) and biscuits may have many different shapes, though preferred wafer(s) and/or biscuit(s) are flat so they can be usefully be laminated together with a confectionery filling of the invention (and optionally a fruit based filling). More preferred wafers are non-savoury wafers, for example having a sweet or plain flavour.

A non-limiting list of those possible baked foodstuffs that may comprise chocolate compositions that comprise chocolate product of and/or used in the present invention are selected from: high fat biscuits, cakes, breads, pastries and/or pies; such as from the group consisting of: ANZAC biscuit, biscotti, flapjack, kurabiye, lebkuchen, leckerli, macroon, bourbon biscuit, butter cookie, digestive biscuit, custard cream, extruded snacks, florentine, garibaldi gingerbread, koulourakia, kourabiedes, Linzer torte, muffin, oreo, Nice biscuit, peanut butter cookie, polvorón, pizzelle, pretzel, croissant, shortbread, cookie, fruit pie (e.g. apple pie, cherry pie), lemon drizzle cake, banana bread, carrot cake, pecan pie, apple strudel, baklava, berliner, bichon au citron and/or similar products.

Preferably the chocolate product of or prepared according to the invention may be suitable for use as (in whole or in part as a component) of one or more coatings and/or fillings.

The coating and/or filling may comprise a plurality of phases for example one or more solid and/or fluid phases such as fat and/or water liquid phases and/or gaseous phases such as emulsions, dispersions, creams and/or foams.

Therefore, broadly a further aspect of the invention comprises a foodstuff comprising chocolate product as described herein.

A yet further aspect of the invention broadly comprises use of a chocolate product of or prepared according to the invention as a chocolate product confectionery product and/or as a filling and/or coating for a foodstuff of the invention as described herein.

As the process and the production line of the present invention are modular, it enables more artisanal (for example, more individual and complex) products to be produced on an industrial scale. The present invention also affords the opportunity to produce a number of different products on the same production line.

Additionally, the cooling process of the present allows the production of chocolate with improved bloom properties and/or a preferential crystalline form distribution when compared to typical industrially produced chocolate.

### Moulds

As mentioned above, the present invention relies on the use of moulds containing the confectionery product and the product is transported around the production line within these moulds until the demoulding step. In a preferred embodiment, the confectionary is contained within at least one mould during the cooling step, which is defined in more detail below.

In a preferred embodiment, the moulds for use in the present invention may be made from any material that is able to withstand the physical and chemical stresses placed on a mould during the confectionery production process and meet the necessary hygiene requirements for use in the food industry. In a preferred embodiment, the moulds are made from a thermoplastic polymer. For example, the moulds comprise a thermoplastic polymer containing carbonate groups (a polycarbonate). In a preferred embodiment, the moulds are made from materials comprising a polymer that contains a bisphenol A and carbonate groups in the monomeric unit. Specific examples of such polymers are sold under the tradenames Lexan® by SABIC, or Makrolon® by Bayer MaterialScience. Alternatively, the moulds may be prepared from a blend of polycarbonate and acrylonitrile butadiene styrene.

The moulds for use in the present invention are not limited to particular base shape, i.e. the cross section of the x and y axes when viewed down the z axis in standard axes convention. However, it is preferred that base shape of the moulds is such that adjacent moulds adjoin such that any free space between the moulds is minimised. For example, in a preferred embodiment, each of the moulds has generally rectangular or generally square base.

The size of the moulds is not particularly limited and is dependent on the confectionery product being produced and the size of the process and robot modules being used in the process. However, in a preferred embodiment of the present invention, the moulds have a length in the x direction of between 200 mm and 1500 mm, between 400 mm and 1200 mm, or between 600 mm and 1000 mm. In a preferred embodiment, the moulds have a breadth in the y direction of between 50 mm and 500 mm, between 150 mm and 450 mm or between 200 mm and 400 mm. In a preferred embodiment, the moulds have a height in the z direction of between 5 and 100 mm, between 10 mm and 75 mm or between 20 mm and 50 mm. Any of the above proportions for x, y and z may be combined as long as structural integrity is maintained. For example, in an embodiment of the present invention the mould has x, y and z dimensions of between 600 mm and 1000 mm, between 200 mm and 400 mm and between 20 and 50 mm.

In a preferred embodiment of the present invention, the moulds have a useful dimension (i.e. the portion of the mould where cavities may be present) for cavities within the following preferred dimensions. In a preferred embodiment of the present invention, the moulds have a useful length in the x direction of between 180 mm and 1400 mm, between 350 mm and 1100 mm, or between 700 mm and 950 mm. In a preferred embodiment, the moulds have a useful breadth in the y direction of between 40 mm and 450 mm, between 80 mm and 400 mm or between 150 mm and 360 mm. In a preferred embodiment, the moulds have a useful height in the z direction of between 4 and 80 mm, between 8 mm and 65 mm or between 20 mm and 45 mm. Any of the above proportions for x, y and z may be combined as long as structural integrity is maintained. For example, in an embodiment of the present invention the mould has x, y and z dimensions where cavities may be present of between 550 mm and 1100 mm, between 180 mm and 400 mm and between 20 and 45 mm.

In an embodiment of the present invention the moulds used may all have essentially the same size (i.e. when taking into account minor manufacturing variations). However, it is not essential that the moulds are all the same size. As long as the moulds may be stacked securely, different sized moulds may be used. In an embodiment of the present invention, if more than one stack of moulds is required for any process step, different sized and shaped moulds may be used in each stack. In a preferred embodiment, the present invention utilises the same sized and shaped mould for making a batch of a particular product in order to ensure case of mould handling and mould stacking.

In a preferred embodiment of the present invention, the upper face of the mould contains at least one mould cavity that is used to form the target confectionery. The at least one mould cavity is formed within the walls of the mould. In a preferred embodiment, when the moulds have a generally square or rectangular based, the at least one mould cavity is formed by a pairs of walls of opposing sidewalls extending from the base. In a preferred embodiment, there may be further dividing walls or dividing portions between the pairs of opposing sidewalls to form a plurality of mould cavities.

The shape, size and number of mould cavities present in the moulds are not particularly limited and are dependent on the confectionery being produced and the size of the moulds used. In a preferred embodiment, each mould may contain between 1 and 400 cavities, 1 and 250 cavities, between 10 and 200 cavities, between 25 and 180 mould cavities, between 50 and 150 mould cavities.

In a preferred embodiment, each cavity may had x, y and z dimensions of between 10 mm, 10 mm and 10 mm and between 300 mm, 200 mm, and 50 mm.

By virtue of the method of the present invention reducing the mechanical stress on the moulds, it is possible to minimise “dead space” in the moulds, e.g. portions of the moulds that do not contain cavities and were present to ensure significant structural stability of the mould to protect against the damage caused by strenuous motion in a traditional production line—particularly at the sides of traditional moulds. Hence, for example, the upper surface of the mould is greater than 75%, greater than 80% or greater than 90% covered by cavities and/or less than 95%.

In a preferred embodiment, the moulds for use in the present invention include features that enable the gripping portions of the effectors of the robotic modules to interlock with the moulds to enable secure movement of the moulds between process modules and when stacking and unstacking said moulds.

In a preferred embodiment of the present invention, these features of the moulds may be a plurality of extended or recessed features that align with corresponding recessed or extended features present in the effector of a robotic module. These features are preferably on at least one pair of opposing sidewalls of the moulds, e.g. the face and back of the moulds and/or the sides of the mould and on each corresponding gripping portion of the effector. The shape of the corresponding extended and recessed features is not particularly limited, for example, they may be cuboid, cylindrical, pyramidal, hemi-spherical, cone-shaped, or truncated cone-shaped etc. In a preferred embodiment, when the features are recessed, the recess is open ended at both ends or the recess is open ended at only the end where interaction with the effector takes place.

In a preferred embodiment, the moulds contain recessed features and the gripping portion of the effector comprises corresponding protruding features so that alignment of the moulds with adjacent moulds is not prejudiced.

In a preferred embodiment, the number of extended or recessed features on each of the opposing side walls of the mould and on the corresponding gripping arm of the effector is greater than or equal to 1, for example 2, 3, 4 or 5. In a preferred embodiment, the number of extended or recessed features is less than 10. The number of extended or recessed features on the sidewall of the mould and the corresponding gripping portion of effector is the same to allow accurate and secure mating.

The exact position and size of the features that enable mating between the gripping portion of the effector and the mould are not particularly limiting. These features simply need to have the requisite properties to enable a secure gripping of the moulds.

In a preferred embodiment of the present invention, the moulds comprise features that allow a flow of fluid, preferably gas, through a mould and/or between two moulds stacked, together that is sufficient to aid cooling of the confectionery. In a preferred embodiment, when two moulds are stacked one on top of the other a gap is formed between a portion of the bottom mould and a portion of the top mould. In an alternative preferred embodiment, these features are apertures that are formed in an individual mould and/or are apertures that are formed between two adjacent moulds stacked one on top of the other one. In embodiments of the present invention, these apertures extend in the x or y axes directions through the moulds. The apertures do not interact with the mould cavities in any way to prejudice the structural integrity of the mould cavities. In a preferred embodiment, these apertures extend through the entire length of the mould in the x or y axes. In a preferred embodiment, the apertures are arranged along the longest dimension of the mould, i.e. the x axis, and through the entire length of the y axis of the mould.

In a preferred embodiment of the present invention, each aperture has an individual cross-section of between 250 mm² and 3000 mm², optionally between 400 mm² and 2500 mm², optionally between 500 mm² and 2000 mm², optionally between 500 mm² and 1500 mm², optionally between 750 mm² and 1250 mm² and optionally between 900 mm² and 1100 mm².

In a preferred embodiment, the moulds have between 1 and 25 apertures, preferably between 2 and 20 apertures, optionally between 5 and 15 apertures, and optionally between 7 and 12 apertures.

In a preferred embodiment, the total cross-section of the apertures is between 500 mm² and 60000 mm², optionally between 2000 mm² and 30000 mm² and optionally between 8000 mm² and 20000 mm². For example, for the preferred embodiments based on the typical size of confectionery products, the apertures may have a total cross section of between 2000 mm² and 10000 mm², preferably between 3000 mm² and 9000 mm².

By increasing the size of the aperture it is possible to improve the uniformity of air flow through the mould.

The shape of the apertures is not particularly limited, however in embodiments of the present invention, the apertures may be square, rectangular, triangular, circular, hexagonal, trapezoid, any regular polygon, a truncated version of any of the previously listed shapes or the alike. The apertures do not have to be the same size or shape on each mould or in all moulds used. In a preferred embodiment, the apertures are shaped such to ensure a consistent cooling across the entire mould, for example by using apertures of essentially the same volume and cross-section.

In a preferred embodiment, the apertures for allowing a flow of fluid, preferably gas, through the mould are on a different pair of sidewalls from the features that interact with the gripping portion of the effector. In a preferred embodiment, there are no apertures that allow for flow of fluid, preferably gas, (e.g. escape of gas) on the side of the mould with the features that interact with the gripping portion, i.e. flow of gas through the mould is essentially in one direction.

In an alternative embodiment, the only apertures in the mould are those that allow the majority of the fluid, preferably gas, flow to be in one direction.

In a preferred embodiment, the apertures for allowing the flow of fluid, preferably gas, through the mould are on the pair of sidewalls of the mould along the x axis and the features that interact with the gripping portion are on the pair of sidewalls of the mould along the y axis. In a preferred embodiment of this aspect there are no apertures in the mould that allow the flow of air other than those on the y axis—i.e. the flow of gas is essentially down the y axis through the mould.

In an alternative preferred embodiment, the gripping portion are on the same sidewalls as the apertures.

In a preferred embodiment, the moulds have protrusions that extend, preferably in the z direction, from either or both of the upper and lower faces of the base to enable the formation of apertures between stacked moulds. In an embodiment of the present invention, these features protrude between 5 mm and 50 mm, for example between 10 mm and 30 mm or between 15 mm and 25 mm. There protrusions extend from at least a portion of mould base to enable secure stacking and sufficient gas flow between the moulds, for example the protrusions are over 5% and less than 90% of the base, over 10% and less than 75% of the base, or over 20% and less than 50% of the base, or less than 25% of the base and over 5% of the base. The size and shape of the protrusions is not particularly limited as long as they are sufficient to ensure stacking of the moulds. Alternatively, magnets could be used to align the arrangement of the moulds on the mould base with corresponding magnets being placed accordingly.

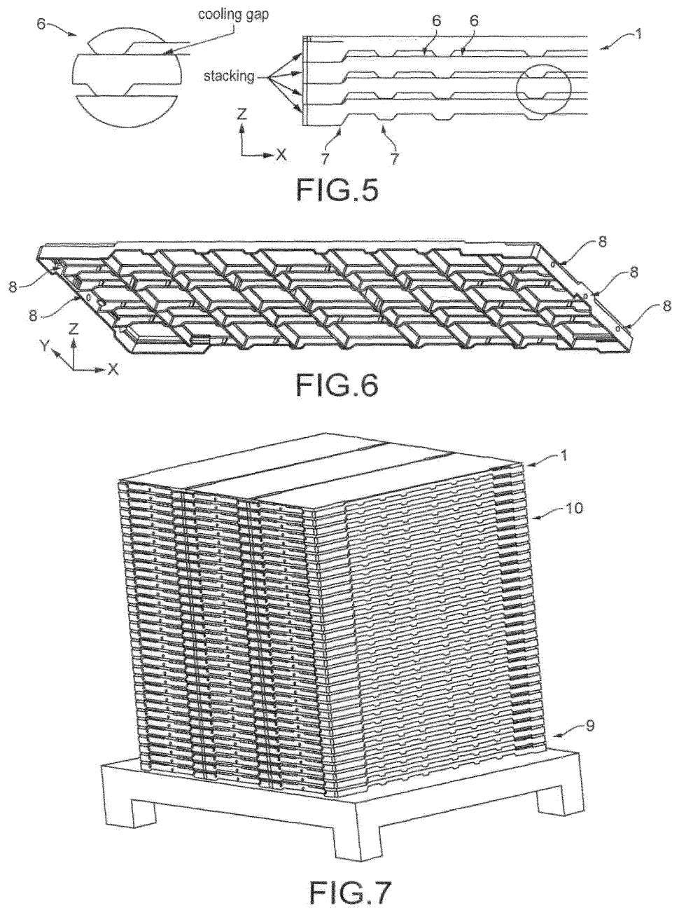

In an embodiment, the protrusions along the two opposing edges of the mould along the y axis of the mould protrude further along the z axis, i.e. protrude further from the base of the mould, than the protrusions not along the edge (i.e. the external protrusions protrude further than the internal protrusions). For example, see FIG. 5.

However, in an embodiment, at least one dimension of the protrusions is minimised to ensure a uniform flow of gas through the moulds. In an embodiment, the width of the protrusion along the x axis is minimised to ensure a uniform flow of gas. In an embodiment, the protrusions have a width along the x axis of between 1.5 mm and 15.0 mm, preferably between 2.0 mm and 12.5 mm and preferably between 2.5 mm and 5.0 mm. In an embodiment, the protrusion is the same width along the y axis. In an alternative embodiment, the protrusion varies in width along the y axis.

In an embodiment, the protrusions extend along a direction (i.e. along the y axis) of the mould to form channels for the apertures to allow gas flow through the mould. In an embodiment, the apertures mentioned above, preferably 2 to 20 apertures, are defined by rows of protrusions along the y axis. In an embodiment, where n is the number of apertures, there are n+1 rows of protrusions extending along the y axis of the mould. For example, if there are 5 apertures, there are 6 rows of protrusions along the y axis forming the apertures.

In a preferred embodiment, when at least two stacks of moulds are arranged adjacent to each other, the features that allow gas flow are arranged such that gas may flow through adjacent stacks of moulds. In a preferred embodiment, the adjacent stacks of moulds are in direct contact in order to aid the formation of a seal so that the efficiency of gas flow between adjacent stacks is maximised.

### Cooling Step

In one aspect, the present invention provides a modular cooling step in a confectionary production process.

In one aspect, the present invention provides a cooling step that is carried out at a temperature that is higher than the traditional confectionery cooling process, for example, the cooling is carried out at a temperature higher than the temperature in a traditional cooling tunnel.

In one aspect, the present invention provides a cooling step that occurs external to the remainder of the production process. In a preferred embodiment, the term external relates to a cooling step that is mechanically independent and/or spatially independent from the remainder of the production process, i.e. it is an out of process line cooling step.

Alternatively, the present invention preferably provides a cooling step that is in line. Preferably, by in line, the cooling module is in conjunction, e.g. physical attachment, with at least one other process module, preferably at least two other process modules, e.g. is an integrated part of the process line. In a preferred embodiment, at least one stack of moulds is cooled in line using the cooling process of the present invention.

In one aspect, the present invention provides a cooling step that is carried out whilst the confectionary is stationary, preferably the confectionary is contained within at least one mould that is stationary. Thus, in an embodiment of the present invention there is no need for a cooling tunnel that relies on a moving conveyor in order to ensure that the production process is continuous.

In one aspect, the present invention provides a cooling step where stacking of the moulds occurs at the same time as the cooling process of the present invention, preferably as the moulds are being stacked they are cooled by the cooling parameters and cooling device described herein. In a preferred embodiment, the stacking is carried out by a robotic module as described below.

In a preferred embodiment of the present invention, the cooling step in a confectionary production process comprises at least two features selected from: 1. a modular cooling step, 2. a cooling step that is carried out at a temperature that is higher than the traditional confectionery cooling process, 3. a cooling step that occurs external to the remainder of the production process, and 4. a cooling step that is carried out whilst the confectionary is stationary.

In preferred embodiments of the present invention, at least features 1 and 2 are present, at least features 1 and 3 are present, at least features 1 and 4 are present, at least features 1, 2 and 3 are present, at least features 1, 2 and 4 are present and at least features 1, 2, 3 and 4 are present.

In a preferred embodiment, the cooling step is carried out at a temperature that is higher than the traditional confectionery cooling process, preferably at a temperature greater than 6.0° C., greater than 8.0° C., greater than 10.0° C., greater than 11.5° C., greater or equal to 12.0° C. greater or equal to 14.0° C., or greater or equal to 15.0° C.

In a preferred embodiment, the cooling is carried out at temperature of greater than 16.0° C., optionally at a temperature of greater than 16.5° C., greater than 17.0° C., greater than 18.0° C. greater than 18.5° C., or greater than 19.0° C.

In a preferred embodiment of the present invention, the cooling is carried out at a temperature of less than 25.0° C., optionally at a temperature of less than 24.5° C., less than 24.0° C., less than 23.5° C., less than 22.5° C. or less than 22.0° C.

In a preferred embodiment, cooling is carried out a temperature between 10.0° C. and 25.0° C. In a preferred embodiment, cooling is carried out a temperature between 12.0° C. and 25.0° C. In a preferred embodiment, the cooling process is carried out a temperature between 16.0° C. and 25.0° C. This temperature relates to the temperature of the gas, preferably air, used in the cooling process. In an embodiment, this temperature relates to the gas that surrounds the moulds and confectionery in the moulds, for example in contact with the confectionery in the moulds, i.e. the gas that is used in the cooling process, for example the gas blown or sucked through/over/around the moulds by the cooling apparatus, if used. In an embodiment, this temperature may be the ambient temperature or if the cooling step takes place within a container, the temperature of the gas within the container. In a preferred embodiment, the temperature is taken of the gas blown or sucked through/over/around the moulds preferably prior to the gas coming into contact with the moulds.

In a preferred embodiment, the temperature of any process steps after the cooling step is controlled to be in the range of below 25.0° C., preferably between 10.0° C. and 25.0° C., preferably between 12.0° C. and 22.0° C., preferably between 14.0° C. and 21.0° C., preferably between 16.0° C. and 20.0° C. or preferably between 18.0° C. and 20.0° C.

In a preferred embodiment, the humidity during the cooling process is between 30% and 70%, more preferably between 40% and 60% or between 50% and 55%. In an embodiment, this humidity relates to the gas referred to above, for example ambient air or air inside the container used in the cooling process. In a preferred embodiment, the humidity is controlled within the above ranges during other process steps, for example demoulding.

In a preferred embodiment, the cooling is carried out for a time period of greater than 15 minutes, greater than 20 minutes, greater than 30 minutes, greater than 40 minutes, greater than 50 minutes, greater than 60 minutes or greater than 70 minutes. In a preferred embodiment of the present invention, the cooling is carried out for a time period of less than 240 minutes, optionally for a time period of less than 180 minutes, less than 120 minutes, less than 110 minutes, less than 100 minutes, less than 90 minutes or less than 75 minutes. In a preferred embodiment, the cooling process is carried out for a time period between 15 minutes and 240 minutes or between 20 minutes and 240 minutes. Preferably, the cooling period is between 15 minutes and 120 minutes, between 15 minutes and 90 minutes, between 20 minutes and 75 minutes, between 20 minutes and 60 minutes or between 20 minutes and 45 minutes.

In an embodiment, if the product to be produced is a composite product, e.g. comprises multiple chocolate product components, comprises a chocolate-product shell and a filling, comprises a chocolate-product shell and baked component etc., the individual elements may be cooled using the process of the present invention or the entire composition may be cooled using the process of the present invention. If the elements are cooled individually, the cooling steps may each be shorter than the periods mentioned above. For example, for cooling each component, e.g. for cooling a chocolate-product shell, the cooling period may be between 1 minute and 15 minutes, between 2 minutes and 10 minutes, or between 3 minutes and 7 minutes.

In an embodiment, the cooling period may be increased as the cooling temperature is increased.

In a preferred embodiment, the cooling step is carried out at a temperature within the range between 10.0° C. and 22.5° C. and for a time period between 20 minutes and 240 minutes, preferably within the temperature range of between 12.0° C. and 20.0° C. and for a time period between 30 minutes and 60 minutes.

In a preferred embodiment, the cooling step is carried out a temperature within the range between 16.0° C. and 25.0° C. and for a time period between 20 minutes and 240 minutes, preferably within the temperature range of between 19.0° C. and 22.0° C. and for a time period between 30 minutes and 240 minutes.

Preferred combinations of cooling temperatures and cooling periods are greater than 12.0° C. and greater than 15 minutes and less than 21.5° C. and less than 80 minutes, greater than 14.0° C. and greater than 15 minutes and less than 20.5° C. and less than 60 minutes, greater than 14.5° C. and greater than 20 minutes and less than 20.0° C. and less than 60 minutes and greater than 15.0° C. and greater than 20 minutes and less than 19.5° C. and less than 50 minutes.

The selection of cooling parameters may be made dependent on the confectionery product being cooled. The present invention affords flexibility in that the same apparatus may be used to cool different confectionery products in rapid succession, i.e. as the present invention preferably uses ambient air and a modular cooling device, moulds containing different products may be rapidly interchanged without the need for a prolonged modification of a moulding line and/or modification of a cooling tunnel.

In a preferred embodiment, the cooling temperature is set at a constant temperature, within experimental variation (i.e. ±0.5° C. or ±0.2° C.) during the cooling step. In an alternative preferred embodiment, the cooling temperature is not set at a constant temperature, within experimental variation (i.e. ±0.5° C. or ±0.2° C.) during the cooling step. In a preferred embodiment, the cooling step may contain at least two time periods with differing cooling temperatures. In an embodiment, this means that the cooling step may include an increasing or decreasing temperature gradient that may be continuous or discreet. For example, the cooling step may comprise a first time period of cooling at a lower temperature and a second time period of cooling at a higher temperature, and vice versa, wherein both temperatures are within the above ranges and the sum of the first and second time periods is within the above ranges. For example, the cooling step may comprise an initial temperature, which is then decreased or increased to give a final temperature over the entire time period of cooling, wherein the initial and final temperatures are within the above ranges and the total time period is within the above time periods. For example, the cooling step may comprise at least one discreet, constant cooling step in combination with at least one variable cooling step, as defined above.

In a preferred embodiment, there are between at least 2 time periods and 5 time periods, preferably between 2 and 3 time periods, for the cooling process. These time periods provide distinct cooling zones. In a preferred embodiment, the temperature across these time periods/zones decrease and then increases in order to reduce the risk of condensation. For example, in a three zone cooling step, higher temperature at the beginning, low in the middle and raised at the end to reduce the risk of condensation.

In the invention, the fluid exiting the moulds after cooling is at a temperature that is higher than the fluid entering the moulds. This temperature difference is dependent on a number of factors including, the temperature of the confectionery, the temperature of the fluid entering the moulds, the flow rate of the fluid used in cooling, the quantity and type of confectionery, volume of the fluid used in cooling etc. However, in an embodiment of the invention, the temperature of the fluid exciting the moulds is between 2° C. and 12° C. or between 4° C. and 12° C. higher than the temperature of the fluid entering the moulds, optionally between 6° C. and 10° C. higher. Over the course of the cooling step, the temperature difference between air entering the mould and air exciting the mould will decrease. In an embodiment, the above temperature difference relate to the temperature differences at the start and/or end of the cooling step.

In a preferred embodiment, cooling of the moulds is carried out using a cooling apparatus (cooling module), for example a fan or ventilator, that is capable of propelling a gas through apertures in the moulds or drawing gas through said apertures. In an embodiment of the present invention, the cooling apparatus may comprise a fan with a blade diameter of between 250 mm and 1000 mm, for example 500 mm. For example, the cooling apparatus may be a Vent Axia model BSP50014, 500 mm fan.

In a preferred embodiment, the cooling apparatus comprises a feature that enables movement thereof and the desired alignment with the moulds, for example, the apparatus is on wheels or on a guide rail so that it may be moved into the desired alignment with the moulds.

In a preferred embodiment, the cooling apparatus comprises a feature that enables vertical movement so that the cooling apparatus may be raised and lowered to ensure alignment with moulds at different heights. There is no particular limitation on the nature of the lifting apparatus, e.g. may be mechanical, hydraulic, manual etc.

In a preferred embodiment, the cooling apparatus comprises a feature that enables the formation of a suitable seal between the apparatus and the moulds such that is no loss of flow rate to the surrounding area.

In a preferred embodiment, the gas used in the cooling step is air. However, alternatively, the gas used may be an inert gas, for example nitrogen.

In a preferred embodiment of the present invention, a single cooling apparatus may cool more than one stack of moulds. In an embodiment of the present invention, each cooling apparatus may be used to cool 2 or more stacks of moulds, for example 5 or fewer stacks of moulds.

In a preferred embodiment, the fan or ventilator is set such that the flow of gas through the mould closest to the fan or ventilator is between 4.0 m/s and 20.0 m/s, preferably between 5.0 m/s and 15 m/s, optionally between 5.5 m/s and 12.5 ms/, optionally between 6.0 m/s and 10 m/s and optionally between 6.5 m/s and 8.5 m/s.

In a preferred embodiment, the flow of gas provided by the cooling device, preferably fan or ventilator, preferably when measured adjacent the device, i.e. not through a mould, is between 1.0 m³/s and 10.0 m³/s, optionally between 1.5 m³/s and 7.5 m³/s, optionally between 2.0 m³/s and 5.0 m³/s, optionally between 2.0 m³/s and 4.0 m³/s.

In a preferred embodiment, the total (i.e. through all apertures) volume flow of gas through the each individual mould provided by the cooling device is between 0.004 m³/s and 0.2 m³/s, preferably between 0.008 m³/s and 0.14 m³/s, optionally between 0.01 m³/s and 0.12 m³/s, optionally between 0.02 m³/s and 0.09 m³/s, optionally between 0.03 m³/s and 0.07 m³/s and optionally between 0.035 m³/s and 0.065 m³/s.

By increasing the gas velocity through the moulds, the heat transfer coefficient is increased, which leads preferably to faster cooling.

Accordingly, a preferred embodiment of the present invention comprises a combination of the following features:
the gas flow through all moulds being cooled is between 2.0 m/s and 20.0 m/s, preferably between 5.0 m/s and 10.0 m/s or between 6.0 m/s and 10.0 m/s;
the gas as a temperature of between 10.0° C. and 25.0° C. prior to be used as a coolant, preferably between 12.0° C. and 225.0° C.;
the cooling step is preferably carried out for a period of between 15 minutes and 240 minutes; and
the moulds comprise gas flow apertures with a total cross-section of between 2000 mm² and 30000 mm², preferably between 2000 mm² and 10000 mm², and preferably between 3000 mm² and 9000 mm²;

In a preferred embodiment, the cooling temperature is controlled by the flow of gas through the moulds. Thus, as mentioned above in respect of cooling temperature, in an embodiment of the present invention, the flow of gas may be constant across the cooling step or the flow of gas may be changed across the cooling step. In a preferred embodiment, the cooling step may contain at least two time periods with differing gas flows. In an embodiment, this means that the cooling step may include an increasing or decreasing gas flow gradient that may be continuous or discreet. For example, the cooling step may comprise a first time period of cooling at a lower gas flow and a second time period of cooling at a higher gas flow, and vice versa, wherein both gas flows are within the above ranges and the sum of the first and second time periods is within the above ranges. For example, the cooling step may comprise an initial gas flow, which is then decreased or increased to give a final gas flow over the entire time period of cooling, wherein the initial and final gas flows are within the above ranges and the time period is within the above time periods. For example, the cooling step may comprise at least one discreet, constant cooling step in combination with at least one variable cooling step, as defined above.

In a preferred embodiment, the gas flow is measured using an airflow meter, for example an Alnor TA5hot wire airflow meter. In an embodiment, the airflow meter is placed on the mould so that the flow of gas through an aperture is measured at the side of the mould furthest from the cooling apparatus.

In an embodiment of the present invention, the flow of gas through subsequent moulds is within the ranges mentioned above for the mould closest to the cooling apparatus. In a preferred embodiment, at least two stacks are cooled concomitantly, preferably 2 to 4 stacks, and the flow of gas through all stacks is within the ranges mentioned above. It is noted that the flow of gas is potentially always the highest through the mould closest to the cooling apparatus and the flow of gas does not increase through stacks further from the cooling apparatus.

Alternatively, in embodiments of the present invention, the flow of gas through the first adjacent mould to the mould closest to the cooling apparatus is lower than that through the mould closest to the cooling apparatus.

However, most preferably, the flow rate of gas is constant, preferably as constant as possible, through each stack of moulds. For example, all mould stacks have the flow rate 2.0 and 20.0 m/s, preferably between 5.0 m/s and 10.0 m/s or between 6.0 m/s and 10.0 m/s.

In a preferred embodiment of the present invention, the flow gas through said first adjacent mould (for example, mould B in FIG. 13) is between 3.0 m/s and 18.0 m/s, optionally between 4.0 m/s and 12 m/s, optionally between 5.0 m/s and 8 m/s.

In embodiments of the present invention, the flow of gas through the subsequent adjacent mould (for example, mould C in FIG. 13) to the first adjacent mould is lower than that through the first adjacent mould. In a preferred embodiment of the present invention, the flow gas through said first adjacent mould is between 2.0 m/s and 15.0 m/s, optionally between 3.0 m/s and 10 m/s, optionally between 4.0 m/s and 7.0 m/s.

In an embodiment of the present invention, the flow of gas through stacks of moulds may be controlled by at least one of: changing the direction of gas flow during the cooling step (i.e. changing from sucking to blowing or vice versa); using cooling devices on either side of the moulds, preferably alternating the devices used (e.g. one device is adjacent stack C and one device is adjacent stack A and the devices are alternatively used) and/or the orientation of the moulds are altered during the cooling step, preferably a robot module is used to rotate the moulds by 180° at least once during the cooling step.

In a preferred embodiment, the flow of gas may be alternated between every 2 minutes and every 25 minutes during the cooling step, optionally between every 2.5 minutes and every 15 minutes and optionally between every 3.0 minutes and every 10.0 minutes. The alteration of the direction of the flow of gas preferably provides a more uniform cooling profile through the moulds, i.e. counteracts any effects by having moulds at differing distances from the cooling device.

In a preferred embodiment, the passive cooling at high temperatures is controlled so as not to prejudice the product. With respect to the definition of the term passive cooling, this is cooling that occurs prior to the cooling step (i.e. the active cooling step described above), for example during the deposition process whilst other mould cavities are being filled, during mould stacking, during transport of moulds after deposition and the like. In a preferred embodiment, the period for any passive cooling is less than one hour, more preferably less than 45 minutes, more preferably less than 30 minutes and most preferably less than 20 minutes.

In an embodiment of the present invention, the time period from deposition of the ingredients into the mould to the cooling step of the present process is greater than 1 minute, greater than 5 minutes, for example between 8 and 15 minutes.

The term high temperature in respect of passive cooling is greater than 20.5° C., greater than 22.5° C., greater than 25° C., for example between 27° C. and 35° C. The active cooling occurs at a lower temperature than the passive cooling.

In a preferred embodiment, the moulds used in the present invention may be stacked together, i.e. arranged in a vertical manner. The height of the stacks used is dependent on the process conditions used and the desired throughput of the production line. In a preferred embodiment, the moulds are capable of being stacked in a stack of greater than 2 or more moulds, 5 or more moulds, 10 or more moulds or 20 or more moulds. In a preferred embodiment, the moulds are stacked in stacks of less than or equal to 60 moulds, less than or equal to 50 moulds or less than or equal to 40 moulds.

In an embodiment of the present invention, during the cooling step at least two stacks of moulds may be arranged laterally with each other, i.e. face-to-face, back-to-back, face-to-back or side-to-side. In an embodiment of the present invention, said stacks are arranged as closely as possible to each other, potentially in direct contact.

In a preferred embodiment, the gap between the stacks of moulds is less than or equal to 1 cm, preferably less than 0.75 cm, more preferably less than 0.5 cm, more preferably less than 0.25 cm and most preferably less than 0.1 cm. In a preferred embodiment, the mould stacks are in direct contact or alternatively the gap between the stacks is greater than 0.05 cm. It is beneficial to reduce the gap between the stacks when a cooling apparatus is used in order to minimise any loss in gas flow velocity between the stacks. The same parameters apply to the distance between the cooling apparatus and the stack closest thereto, i.e. it is beneficial to arrange the cooling apparatus as close as possible to the stacks of moulds to ensure efficient cooling. However, this can be controlled to ensure that material is not transferred between the moulds when dirty.

In a preferred embodiment, at least one stack of moulds is placed on a suitable substrate that enables transportation of the at least one stack moulds to a position suitable for carrying out cooling. In an embodiment, the substrate may be a pallet of the appropriate size. In alternative embodiment, cooling takes place in the absence of a substrate.

In an embodiment of the present invention, the substrate is of the appropriate size so that between 2 to 10 stacks of moulds may be loaded thereon, optionally between 2 and 6 stacks of moulds, optionally 3 or 4 stacks of moulds may be loaded thereon.

In an embodiment of the present invention, the substrate comprises protrusions that extend vertically and horizontally from the upper face of the pallet and the protrusions are positioned to enable the secure and accurate positioning of a mould when placed on the pallet. The position of these protrusions is such that they correspond to the size of the moulds being used.

In an embodiment of the present invention, the substrate loaded with at least on stack of moulds may be transported using a vehicle suitable for the task dependent on the size and weight of the stacks of moulds and substrate used. For example, in an embodiment, a forklift truck driven by a human operator or an unmanned autonomous forklift truck (an automated guided vehicle) may be used.

In an embodiment of the present invention, the cooling process takes place in the ambient environment (i.e. the confectionery is open to the ambient conditions, e.g. ambient air temperature and humidity).

In an alternative embodiment, the cooling process takes place in a container, preferably wherein the container may be sealed after insertion of the moulds to create an environment essentially sealed off from the ambient environment.

In an embodiment of the present invention, the container is sized to accommodate at least one stack of moulds, preferably at least two stacks of moulds, preferably at least three stacks of moulds. In an embodiment, the container holds less than 10 stacks of moulds, preferably less than or equal to five stacks of moulds.

In an embodiment, the container comprises a heat exchanger that is suitable for cooling the ambient air around the at least one stack of moulds. The nature of the heat exchanger is not particularly limited, what is important that is capable of reducing the temperature of the ambient air to within the temperature range mentioned above for the cooling step. In an embodiment, the heat exchanger comprises a double pipe heat exchanger, a shell and tube heat exchanger, a plate heat exchanger, a plate and shell heat exchanger, a plate fin heat exchanger, a fluid heat exchanger or a direct contact heat exchanger or combinations of the above.

In an embodiment, the container comprises the cooling device described above. In an embodiment, the container is connected to or encompasses a fan that can blow or suck air through the cabinet and at least one of over/through/between/around etc. the moulds present in the container.

In an embodiment, the cooling device sucks air into the container and over the heat exchanger and over/through/between/around etc. the at least one stack of moulds.

In an embodiment, the container comprises channels that allow re-circulation of the air from around the moulds to the heat exchanger. In an embodiment, the container comprises apertures that allow airflow from the environment to/from the cooling device through the container. In an embodiment, these apertures may be openable and closable. In an embodiment, the container comprises both re-openable apertures and re-circulation channels.

During the positioning of the moulds, it is possible that there are issues that lead to a positioning error, for example errors in substrate location, substrate construction and/or also tolerance of the stacking of the moulds themselves. Therefore, in an embodiment of the present invention, at each lifting cycle, the robot module uses sensors to detect the position of the mould in order to ensure correct picking. In a preferred embodiment, at least two laser sensors may be used to detect the edges and the surface angle of the moulds. Alternatively, a known 3D vision system may be used.

### Robot Module

In the present invention, at least one robot module is used to carry out at least one process step in the confectionery production process. In order to enable each robot module to carry out the process steps the robots comprise a robotic arm and an effector at the end thereof that is designed to interact with the environment. In an embodiment, more than one type of effector is defined for different process steps depending on the particular requirements of that step.

In the present invention, an example of an effector is one that enables the robot module to hold at least one mould in a manner sufficient to enable the appropriate positioning of the mould during the process.

In a preferred embodiment of the present invention, the robot module may hold between 1 and 5 moulds, for example 1, 2, 3, 4 or 5 moulds simultaneously. In the embodiments where more than one mould is held by the robot module, dependent on the process step, the robot module places all moulds in the process module and then separates the stacked moulds into a single layer for processing.

In a preferred embodiment, the effector comprises a gripping portion. The gripping portion may be any of the standard categories known in the art, i.e. impactive (jaws or claws), ingressive (pins, needles or hackles), astrictive (vacuum, magneto- or electroadhesion) or contiguitive. In a preferred embodiment, the gripping portion is impactive, preferably comprising two, three or five fingers.

In a preferred embodiment, one robot will be used for each distinct step of the process as set out above in the preferred embodiments of the present invention.

However, in the case of lower throughput lines it is possible to use one robot to do two or more process steps.

In a preferred embodiment, the robot module is mounted onto a mobile stand unit optionally along with its control box. The robot stand preferably has locking wheels to allow the robot to be moved to any position when building the line. In a preferred embodiment, the robot module has features that enable it to dock and lock to its relevant process module.

In a preferred embodiment, each robot module will have a standard electrical and mechanical interface to any of the process modules so the robot module may be used in any position on the line.

In a preferred embodiment, there is a standard robot program that resides in all of the robots on the line; the program will have a number of subprograms, which cover each process step—depending on which process module the robot is connected to the relevant subroutine will be invoked.

In a preferred embodiment, the robot module comprises a sensor that can detect the presence of the process module. In a preferred embodiment, the process module comprises a tag that the scanner can read, preferably, the tag is used to determine what steps the robot module will carry out when docked with that process module. In respect of the nature of the scanner and tag system, any system that enables the transfer of information from the process module to the robot module may be used. In a preferred embodiment, the process module incorporates a radio frequency identification (RFID) scanner to read an RFID tag on the mould. Alternatively, the process module comprises a sensor and the robot module comprises the tag.

In a preferred embodiment, at least one robot module used is a collaborative robot (i.e. a robot intended to physically interact with humans in a shared workspace—alternatively called force limited robots). Collaborative robots have a simple setup and use, plus a relatively large working range. The fact that the robot modules are collaborative is also useful for reducing the need for fixed and interlocked guarding on the line. In a preferred embodiment, the robot module is based on a Universal Robots UR10 Collaborative Robot. Alternative preferred robots may be Universal Robots UR3 and UR5, Rethink Robots Baxter and Sawyer, Kuka LBR iiwa, ABB Yumi or Fanuc CR-35iA. The definition of collaborative robot may be provided by ISO 10218 part 1 and part 2.

Alternatively, in an embodiment, the robot may be an industrial robot. Industrial robots are capable of improving the throughput of the production process. Examples of industrial robots include vertically articulated industrial robot, for example an FANUC R-2000iB/165F, Staubli—TX2-90, or Kuka Agilus Sixx, optionally configured for pick and place activities.

In a preferred embodiment, each robot module comprises features that enable upstream and downstream interface signals to manage the transfer of loads between the modules. In a preferred embodiment, each process module comprises a receiving feature (preferably an infeed shelf) where the mould is placed by the upstream robot, the current robot module picks the mould from this feature, presents it to the process module, where the necessary process step is carried out and then places the mould on the receiving feature (preferably an infeed shelf) of the downstream module.

In a preferred embodiment, each module comprises features that enable assessment of the presence of moulds on the receiving features. In a preferred embodiment, this process comprises the following steps, a current module signals to the upstream robot that the receiving feature is vacant and the current module robot is out of the way; an upstream robot module will then place a mould onto the receiving feature of the current module; the upstream module places a mould on the receiving feature of the current module and the upstream robot moves out of the way so that it will not collide with the robot of the current module and signals such to the current module; and the current module robot picks the mould from the receiving feature and presents it to the process module for processing.

In a preferred embodiment, each robot module has a basic signal interface with its process module, when the robot has picked its mould from the receiving feature and is ready for the mould to be processed it will signal start processing to the process module, when the process module is complete with processing the mould it will signal back to the robot process complete.

In a preferred embodiment, the robot module may directly control the devices on the process module. In preferred embodiments, a Modbus or similar I/O (Input/Output) bus connection to the process module from the robot modules enables process operation without the need for a PLC as the robot module can directly control the devices on the process module.

### General Process Module

In a preferred embodiment of the present invention, a core process module template defines the basic outline of each process module and its interface to the rest of the production line. The exact specific set up of the process module will depend on its function.

In an embodiment of the present invention, the core process module comprises a frame with locking wheels to enable movement of the module, as well as to secure the position thereof. In a preferred embodiment, the core process module has a receiving feature, preferably an infeed shelf, to receive moulds ready for processing which can be either from the left or the right depending of the handing of the line.

In a preferred embodiment, the process module comprises a sensor that can detect the presence of a mould. In a preferred embodiment, the mould comprises a tag that the sensor can read; preferably the tag is used to determine what steps the process module will carry out on that particular mould. In respect of the nature of the scanner and tag system, any system that enables the transfer of information from the mould to the process module may be used. In a preferred embodiment, the process module incorporates a radio frequency identification (RFID) scanner to read an RFID tag on the mould.

In a preferred embodiment, the core process module has a vertical frame member upon which the necessary functional equipment for the relevant processing step may be attached. It may also have a control panel mounted, preferably at the bottom half, of the vertical pillars. The control panel is preferably a programmable logic controller (PLC).

In a preferred embodiment, the robot module may be docked to the process module. In a preferred embodiment, a process module may dock to adjacent process modules in the line.

In a preferred embodiment, the width of the core process module is standardised according to the working reach of the robot module. For example, a module pitch of between 1200 mm to 2000 mm, preferably between 1300 mm and 1700 mm, for example 1500 mm may be used. The above dimensions give a working space between the vertical members of 1100 mm, giving adequate space for an 800 mm wide mould plus robot gripper.

In a preferred embodiment, the electrical interface between modules is as defined above for the robot module.

More detailed specifications for specific process modules are described below, in preferred embodiments of the present invention, the specific process modules are based on the above-described core process module modified to carry out the appropriate processes.

### Mould Conditioning Module

The function of this module is to preheat the moulds up to a temperature suitable for depositing.

In a preferred embodiment, this will be achieved by passing the moulds (preferably with the long edge leading) under an infrared heater unit.

In a preferred embodiment, the moulds are placed, for example by a robot capable of stacking moulds, onto a conveyor section which will transport the moulds under the heater, at the end of the belt the robot of the next module in the line will pick the mould for processing.

In a preferred embodiment, the infrared heater unit is of a standard design that is commercially available and mounted between 80-100 mm above the surface of the moulds. The heater unit will be supplied complete with its own control panel, and this panel should also be specified to control any additional functions associated with the mould conditioning module in order.

In a preferred embodiment of the present invention, the moulds are preheated to a temperature of preferably between 25° C. and 35° C., most preferably about 30° C. In a preferred embodiment, this step comprising heating the moulds to +/−1° C. of deposited chocolate temperature.

### Mould Stacking and Unstacking Module

In a preferred embodiment, the present invention uses a module that is capable of stacking and unstacking the moulds at a desired point in the production process, for example, in the cooling step of the production process and/or in the initial and final stages of the process of the present invention (i.e. prior to mould conditioning and subsequent to demoulding and mould cleaning).

In a preferred embodiment, this module comprises a robot that is able to stack and/or unstack moulds from a substrate, for example a pallet, and place the moulds on a receiving feature of a process module (depalletiser) and/or remove moulds from its own receiving feature, where the last process module in the line will place its moulds, and place the moulds on a substrate (repalletising).

In a preferred embodiment, the module will have at least two substrate positions, whilst one substrate is being operated on by the robot module, the second one can be changed by the operator.

In a preferred embodiment, the same system as discussed above in respect of the cooling step may be used in the stacking and unstacking steps.

### Depositor Module

In an embodiment of the present invention, a depositor module is used to deposit at least one ingredient of the confectionery into a mould.

In an embodiment of the present invention, a standard commercially available depositor system modified to comprise a receiving feature of the core process module defined above may be used. Alternatively, a standard commercially available depositor may be attached to a core process module as defined above.

In an embodiment of the present invention, a depositor may be used to deposit chocolate.

If only approximate chocolate depositing is required, for example for wet shell depositing or backing off, a more simple depositor may be used when compared to a situation where precise dosing per cavity is needed.

Alternatively, in an embodiment of the present invention, a depositor process module comprises a deposition feature (for example, a plenum chamber or depositor plate) with openings that correspond to cavities on the mould. In an embodiment where the confectionery comprises chocolate, the depositor, comprises a heated hopper from where chocolate is drawn into the deposition feature. In an embodiment, a standard gear pump driven by at least one servo motor which controls speed and volume of dosing controls flow of the chocolate. Typical time for depositing is about 1-3 seconds, depending on the volume of chocolate to be dosed.

It should be noted that unlike a traditional depositor where the depositor head is moved in one or more axis in order to do ribbon depositing etc., in this case the depositor is in a fixed position since the robot can manipulate the mould to give the same functions normally performed by a moving depositor.

In a preferred embodiment of the present invention, the depositor process module is synchronised with the corresponding robot modules. The synchronisation of the robot to the depositor module may be by a start command from the robot to the depositor. Both robot and depositor then perform their preprogramed movements in order to achieve the required result, this can include various speeds and tool paths of the robot as well as wait points, plus various dosing moves of the depositor gears to put the correct amount of confectionery ingredients in the right place of the mould.

In a typical chocolate production process, following depositing it is normal practice to vibrate the mould to help to settle the chocolate.

In an embodiment of the present invention, the shaking could be done by a separate process module. Alternatively, since shaking almost always follows depositing, the depositing module may also carry out the shaking. In this case after the robot module has passed the mould under the depositor it would place the mould onto a shaking conveyor positioned below the depositor. This enables the mould to be shaken whilst the robot module is free to start processing the next mould. Once the mould has reached the end of the shaking conveyor it is picked off by the next robot module in the line for subsequent processing.

### Cooling Module

In a preferred embodiment, the present invention provides a modular production line comprising the features as defined in any of the above-embodiments.

A preferred aspect of this production is a cooling module that is capable of carrying out any of the cooling process steps mentioned above and/or contains any of the features defined above for the cooling process.

In a preferred embodiment, the cooling module comprises at least one robot capable of stacking moulds, preferably in a manner as defined above, and a cooling apparatus that is capable of cooling a confectionery product within a mould, preferably using any of the process steps as defined above. In a preferred embodiment, the robot module may be as defined above and/or the cooling apparatus may be as defined above.

In a preferred embodiment, the cooling module may be connected to or disconnected from the physically interconnected modular production line.

Unless defined otherwise, all technical and scientific terms used herein have and should be given the same meaning as commonly understood by one of ordinary skill in the art to which this invention belongs.

Unless the context clearly indicates otherwise, as used herein plural forms of the terms herein are to be construed as including the singular form and vice versa.

In all ranges defined above, the end points are included within the scope of the range as written. Additionally, the end points of the broadest ranges in an embodiment and the end points of the narrower ranges may be combined.

Embodiments of the present invention will be described in more detail by the following specific, non-limiting examples.

### EXAMPLES

### Example 1

In order to test the impact of the cooling process of the present invention on the final chocolate product, the following trials were carried out.

The chocolate that was chosen for the following investigations was the Dessert Noir Natural Mass from La Panilla with a minimum of 52% Cocoa, made from 42.2% Cocoa paste, 11.5% Cocoa butter, 46.2% sugar, 0.3% sunflower lecithin and without milkfat. The chocolate mass showed a particle size of 21 μm, measured on a Malvern mastersizer.

The moulding of the samples was done manually into moulds, pre-warmed to 30° C. Firstly, six cavities of the 42 g KitKat Chunky mould were filled with an amount of chocolate in order to cover the base of the mould. Subsequently, pre-counted hazelnut nut portions of 13 whole nuts per cavity were deposited manually from a plastic pot for each cavity. The nuts were gently pressed into the chocolate to avoid movement of the nuts to one side of the cavity during the evening off of the bars. Afterwards the remaining volume of the cavities was filled with chocolate and the bars were evened off with a chocolate scraper. The filled moulds were then placed on a vibrating table to force air bubbles out of the chocolate and to enable the nuts to rise to the surface of the bar to be visible as chocolate covered but surface protruding fillings.

The bloom % was measured by counting all nuts and expressing the level of bloom as percentage of bloomed nuts against all nuts. The average was taken across the six moulds and the blooming was assessed manually by eye.

Four samples were cooled at for 0.5, 1, 2, 4 and 72 hours. After nine weeks of storage (ambient 20 deg C., 50% relative humidity) all cooling durations of 0.5, 1, 2, 4 and 72 hours showed an average of 68±3% of bloom. As the standard deviation between the samples was less than 5% the differences in bloom prevalence cannot be regarded as significant.

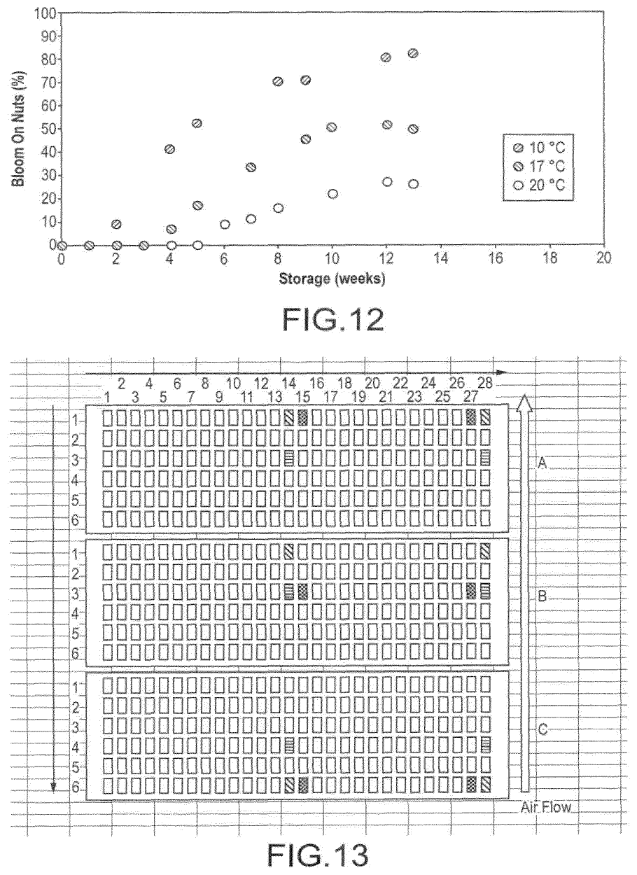

The impact of the cooling temperature on the bloom prevalence of the samples was then tested. As the previous investigation of the cooling duration showed no significant impact on the bloom behaviour, the samples were cooled at 10, 17 and 20° C. for 1, 2 and 3 hours respectively. FIG. 12 displays the results of this study.

It is shown that the cooling process of the present invention provides a reduction in bloom compared to the traditional cooling parameters.

### Example 2

Milk Chocolate was tempered in a Sollich Minitemper Turbo, to a temper index of between 4 and 6 (aiming for 5), with a crystallization temperature between 22.0 and 22.4 C (measured after depositor). 40 kg of chocolate was pumped and purged into a depositor via heated pipework and the depositor jacket set to 30° C. but later raised to 31° C. to ensure adequate flow of chocolate to opposite end of depositor from inlet. Moulds were conditioned to 30° C.

The moulds have dimensions 1122×283×30 mm, with a useable cavity area of 1070×270 mm placed centrally. The trapezoid cavities are internally 26.6×16.5 mm and 9.8 depth. The cavities are separated by 2 mm in the x direction and 10.4 mm in the y direction. The moulds are made from polycarbonate.

The moulds have the profile view as shown in FIG. 5 and contain 7 apertures of trapezium cross-section (x, z axes) through the y axis. The internal protrusions have depth from the base of the mould of 7 mm and the external protrusions (i.e. outermost along x axis) have a depth of 12 mm from the base, i.e. external protrusions extend further. The total cross-section of the apertures is approximately 2500 mm² with approximate individual apertures 275 mm² (x2), 375 mm² (x4) and 525 mm² (x1).

Conditioned moulds were filled by the depositor and backing off was done by hand.

MadgeTech data loggers (OctTemp/Quadtemp Thermocouple Temperature Recorders) were used to measure the temperature within the chocolate across the three stacks of moulds, in a central and side position at two different levels within the stack (bottom/row 1 of 6+center/row 3 of 6).

6 moulds were filled with solids in three rounds, placed centrally in all stacks. 6 moulds were filled with chocolate and placed centrally in section C of the pallet, furthest from the ventilator. 6 moulds were filled with chocolate and placed centrally in section A of the pallet, closest to the ventilator. 6 moulds were filled in the central section B. This is displayed in FIG. 13. The 18 moulds were filled with solids in approximately 25 min, i.e. 0.7 moulds per minute.

The stacks of moulds were placed in three stacks of 30 moulds on a pallet.

The moulds were attached to the ventilator, and the three stacks were in contact against each other, and that the ventilation gaps in the moulds lined up with the ventilator hood, forming a tight seal. The ventilator (Vent Axia model BSP50014, 500 mm fan) was set to draw air through the moulds. Speed setting was at maximum (2.45 m³/s). The ambient temperature was 23.0° C.

The air flow was measured and found to be 7.5 m/s after stack A, 5.6 m/s after stack B, and 4.5 m/s after stack C.

The top row (row 6) was demoulded after 30 minutes, row 5 after 35 minutes, 45 minutes, 60 min, 65 min, 70 min, and the last at 75 min. Demoulding involved three twists applied by hand to the extremities of the moulds, as well as three hits to the central section of the mould.

There was no correlation between sticking in the moulds, cooling time and stack position on the pallet for the solids.

### Example 3

The process of Example 2 was repeated with the following exceptions.

The chocolate was tempered in a Sollich Turbo Temper Champ and the depositor jacket was set to 32° C.

10 moulds were filled with solids in two rounds, placed centrally in the stack closest and furthest from the ventilator 10 moulds were filled with chocolate and placed centrally in section C of the pallet, furthest from the ventilator. 10 moulds were filled with chocolate and placed centrally in section A of the pallet, closest to the ventilator.

The moulds with the temperature probes were demoulded starting at 20 min residence times, in increments of 5 min up to 45 min total cooling time, with the mould filled last demoulded first, i.e. the one on top. For Stack C, there were 4 stickers after 20 min, and none thereafter. For Stack A there were 6 stickers after 20 min, and 3 after 25 min, and none thereafter.

### Examples 4 to 12

The following experiments were carried out with the following parameters (with the same apparatus as described above, unless specified).

| | | | | | | Mould layout |
|---|---|---|---|---|---|---|
| | | | | | Mould | (Cavities/row × |
| | | Product | Weight | | dimensions | cavities |
| Ex. | Shape | Dimensions (mm) | (g) | Process Steps | (mm - x, y, z) | per column) |
| 4 | KITKAT | 26.6 × 16.5 × 9.8 | 4.5 | Tempered | 850 × 310 × 30 | 6 × 28 |
| | Bites | | | (Sollich mini | | |
| | (trapezoid) | | | Temper), | | |
| | | | | deposited | | |
| | | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |
| 5 | KITKAT | 26.6 × 16.5 × 9.8 | 4.5 | Tempered | 850 × 310 × 30 | 6 × 28 |
| | Bites | | | (Sollich mini | | |
| | (trapezoid) | | | Temper), | | |
| | | | | deposited | | |
| | | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |
| 6 | KITKAT | 26.6 × 16.5 × 9.8 | 4.5 | Tempered | 850 × 310 × 30 | 6 × 28 |
| | Bites | | | (Sollich mini | | |
| | (trapezoid) | | | Temper), | | |
| | | | | deposited | | |
| | | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |
| 7 | KITKAT | 26.6 × 16.5 × 9.8 | 4.5 | Tempered | 850 × 310 × 30 | 6 × 28 |
| | Bites | | | (Sollich mini | | |
| | (trapezoid) | | | Temper), | | |
| | | | | deposited | | |
| | | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |
| 8 | KITKAT | 26.6 × 16.5 × 9.8 | 4.5 | Tempered | 850 × 310 × 30 | 6 × 28 |
| | Bites | | | (Sollich | | |
| | (trapezoid) | | | Turbotemper | | |
| | | | | Champ), | | |
| | | | | deposited | | |
| | | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |
| 9 | KITKAT 2 | 93.5 × 31.6 × 9.7 | 28 | Tempered | 850 × 310 × 30 | 3 × 14 |
| | Finger | | | (Sollich | | |
| | (trapezoid) | | | Turbotemper | | |
| | | | | Champ), | | |
| | | | | deposited | | |
| | | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |
| 10 | KITKAT 2 | 93.5 × 31.6 × 9.7 | 28 | Tempered | 850 × 310 × 30 | 3 × 14 |
| | Finger | | | (Sollich | | |
| | (trapezoid) | | | Turbotemper | | |
| | | | | Champ), | | |
| | | | | deposited | | |
| | | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |
| 11 | Les | 191.5 × 90.8 × 14.3 | 235 | Tempered | 850 × 310 × 35 | 3 × 4 |
| | Recettes de | | | (Sollich | | |
| | L'Atelier | | | Turbotemper | | |
| | (4 × 5 half | | | Champ), | | |
| | cylindrical | | | deposited | | |
| | segments) | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |
| 12 | Les | 191.5 × 90.8 × 14.3 | 235 | Tempered | 850 × 310 × 35 | 3 × 4 |
| | Recettes de | | | (Sollich | | |
| | L'Atelier | | | Turbotemper | | |
| | (4 × 5 half | | | Champ), | | |
| | cylindrical | | | deposited | | |
| | segments) | | | (Ribbon | | |
| | | | | Depositor), | | |
| | | | | shaker, | | |
| | | | | licking | | |
| | | | | roller | | |
| | | | | (Sewtek), | | |
| | | | | offline | | |
| | | | | batch | | |
| | | | | cooling, | | |
| | | | | demoulding | | |

| | | Gas Flow apertures | | | |
|---|---|---|---|---|---|
| | | (all trapezium cross | Cooling | | |
| | | section along x axis), | parameters, | Cooling | |
| | Temper | number, cross section | temperature and | Time | Cooling |
| Ex. | Index | and support | air flow speed | (min) | device |
| 4 | 5 ± 1 | 7 × 596 mm², | 18° C., | 30 | Fan unit |
| | | intersected by six | Stack A 7.5 | | only |
| | | support legs | m/s, Stack B | | |
| | | measuring 7 × 15 | 5.6 m/s, Stack | | |
| | | mm, long edge | C 4.5 m/s | | |
| 5 | 5 ± 1 | 7 × 596 mm², | 18° C., | 35 | Fan unit |
| | | intersected by six | Stack A 7.5 | | only |
| | | support legs | m/s, Stack B | | |
| | | measuring 7 × 15 | 5.6 m/s, Stack | | |
| | | mm, long edge | C 4.5 m/s | | |
| 6 | 5 ± 1 | 7 × 596 mm², | 18° C., | 40 | Fan unit |
| | | intersected by six | Stack A 7.5 | | only |
| | | support legs | m/s, Stack B | | |
| | | measuring 7 × 15 | 5.6 m/s, Stack | | |
| | | mm, long edge | C 4.5 m/s | | |
| 7 | 5 ± 1 | 7 × 596 mm², | 18° C., | 45 | Fan unit |
| | | intersected by six | Stack A 7.5 | | only |
| | | support legs | m/s, Stack B | | |
| | | measuring 7 × 15 | 5.6 m/s, Stack | | |
| | | mm, long edge | C 4.5 m/s | | |
| 8 | 5 ± 1 | 7 × 596 mm², | 12° C., ~5 m/s | 60 | Fan unit |
| | | intersected by six | | | only |
| | | support legs | | | |
| | | measuring 7 × 15 | | | |
| | | mm, long edge | | | |
| 9 | 5 ± 1 | 7 × 750 mm², | 19.5° C., ~5 m/s | 60 | Fan unit |
| | | intersected by eight | | | only |
| | | support legs | | | |
| | | measuring 7 × 15 | | | |
| | | mm, long edge | | | |
| 10 | 5 ± 1 | 7 × 750 mm², | 12° C., ~5 m/s | 60 | UK |
| | | intersected by eight | | | Exchangers, |
| | | support legs | | | Finned |
| | | measuring 7 × 15 | | | tube heat |
| | | mm, long edge | | | exchanger |
| | | | | | with fan |
| | | | | | FC-07 - |
| | | | | | Stock |
| | | | | | Copper |
| | | | | | Tubes |
| 11 | 7 ± 1 | 8 × 750 mm², | 12° C., ~5 m/s | 90 | UK |
| | | intersected by eight | | | Exchangers, |
| | | support legs | | | Finned |
| | | measuring 8 × 15 | | | tube heat |
| | | mm, long edge | | | exchanger |
| | | | | | with fan |
| | | | | | FC-07 - |
| | | | | | Stock |
| | | | | | Copper |
| | | | | | Tubes |
| 12 | 4 ± 1 | 8 × 750 mm², | 12° C., ~5 m/s | 90 | UK |
| | | intersected by eight | | | Exchangers, |
| | | support legs | | | Finned |
| | | measuring 8 × 15 | | | tube heat |
| | | mm, long edge | | | exchanger |
| | | | | | with fan |
| | | | | | FC-07 - |
| | | | | | Stock |
| | | | | | Copper |
| | | | | | Tubes |

All samples were taken in 3 stacks of 33 moulds.

Each example was 100% milk chocolate and demoulded at 100% success.

### Example 13

In order to assess the impact of the cooling process of the present invention in contrast to chocolate samples prepared using an industrially standard cooling tunnel differential scanning calorimetry (DSC) tests were carried out using the following experimental protocol.

The DSC results were obtained using a heat shock method: hold for 5 minutes at 15° C., cool to −30° C. at 200° C./minute, hold for 10 minutes at −30° C., heat from −30° C. to 33° C. at 200° C./minute, cool back to −33° C. at 200° C./minute, hold for 10 minutes at −30° C. and heat from −30° C. to 70° C. at 40° C./minute.

Samples 1 and 2 were milk chocolate as above but cooled on a commercially available Aasted, cooling tunnel operating at 10° C.

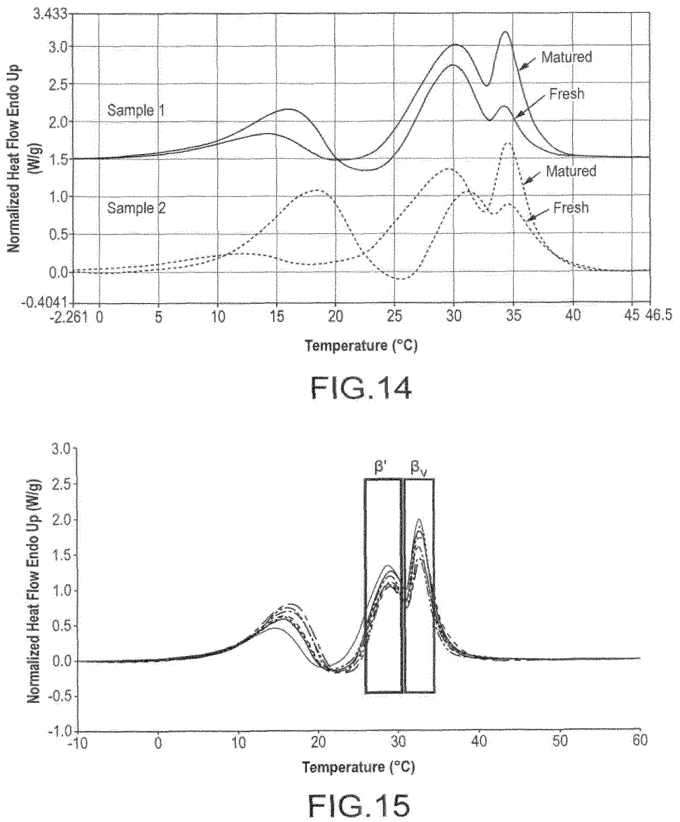

For FIG. 14, the y axis is Normalised Heat Flow Endo Up (W/g), −0.404 to 3.433, in 0.5 increments between 0 and 3 and the x axis is temperature −2.26° C. to 46.5° C. in 5° C. increments between 0 and 45.

For FIG. 15, the y axis is Normalised Heat Flow Endo Up (W/g), −1 to 3, in 0.5 increments and the x axis is temperature −10° C. to 60° C. in 10° C. increments.

FIG. 14 shows two industrially prepared chocolate samples and FIG. 15 shows an overlay of 8 samples, 4 each from Examples 11 and 12 taken from positions spread amongst the stacks so as to provide an accurate average. The term “fresh” relates to samples that are 2 days old and the term “matured” to samples that are 2 weeks old at temperatures between 18° C. and 20° C.

As can be seen, the present invention provides a Superior ratio of β′ and β_{V} for a fresh sample, compared to industrial examples shown previously.

### Example 14

A computation fluid dynamics simulation was based on a mould with aperture heights of 21 mm and 26 mm and a total aperture width of 320 mm, the aperture cross section is taken as the product of these dimensions, for differing gas flow velocities, v. The results are shown below:

| V | gap size | m | Delta p | T -out | Delta T | h computed |
|---|---|---|---|---|---|---|
| m/s | mm | kg/s | Pa | Deg C. | Deg C. | W/m\hat{ }2K |
| 5 | 21 | 0.04116 | 195 | 21.8 | 14.3 | 45.2 |
| 7 | 21 | 0.057624 | 350 | 21.3 | 14.7 | 57.4 |
| 10 | 21 | 0.08232 | 720 | 20.9 | 14.9 | 76.6 |
| 5 | 26 | 0.05096 | 116 | 19.7 | 15.7 | 41.8 |

It is shown that an increased pressure drop occurs at higher flow velocity. At higher flow velocities, the mass flow rate increases but so does the heat transfer coefficient, thus the outlet air temperature does not decrease significantly. This is considered to imply that the cooling process is faster, but may not cause a significantly more uniform cooling time between different positions in the mould. An increased aperture size is considered to have a more significant impact in reducing the outlet air temperature, thus leading to a more uniform cooling step.

1: A process for producing confectionery that comprises a modular step of cooling the confectionery.

2: The process of claim 1, wherein the cooling is carried out at temperature of greater than 16.0° C.

3: The process of claim 1, wherein the cooling is carried out for a time period of greater than 15 minutes.

4: The process of claim 1, wherein the confectionery is cooled in at least one mould.

5: The process of claim 4, wherein the confectionery is cooled in at least two moulds that are stackable with each other.

6: The process of claim 1, wherein the confectionery is stationary during the cooling step.

7: The process of claim 4, where the at least one mould comprises features that allow a flow of gas through said mould and/or between two of said moulds when stacked together.

8: The process of claim 1, where the cooling is carried out using a cooling apparatus.

9: The process of claim 8, wherein the cooling apparatus provides a flow of gas through the features that allow a flow of gas through the mould.

10: The process of claim 9, wherein the flow of gas has a speed of between 2.0 and 20.0 m/s.

11: A process for producing confectionery that comprises the use of modular equipment to perform at least one step in the confectionery production, wherein said at least one step is carried out by a robot module.

12: The process of claim 11, wherein the confectionery is produced in at least two moulds and the at least one process step carried out by a robot module is the stacking and/or unstacking of said moulds.

13: A modular production line comprising a process for producing confectionery that comprises a modular step of cooling the confectionery.
